(19) United States
(12) Patent Application Publication
(10) Pub. No.: US 2007/0062364 A1
(43) Pub. Date: Mar. 22, 2007

(54) Pneumatic actuator

(76) Inventor: Rolf Luchsinger, Uster (CH)

Correspondence Address: JENKENS & GILCHRIST, PC, 1445 ROSS AVENUE, SUITE 3200, DALLAS, TX, 75202, US

(21) Appl. No.: 10/573,524

(22) PCT Filed: Sep. 21, 2004
(86) PCT No.: PCT/CH04/00593

§ 371 Date: Nov. 10, 2006

(30) Foreign Application Priority Data
Sep. 26, 2003 (CH) 1644/03

(51) Int. Cl. F15B 21/00

(52) U.S. Cl. 91/5

(57) ABSTRACT

A pneumatic actuator consisting of an elongate, substantially cylindrical hollow body (1) impinged upon by a pressurized fluid. A pressure rod (2) which is resistant to bending and which can be stressed by axial forces is placed on the lower side thereof. The free end thereof is embodied as a node (3) to which two traction elements (4) are secured and the other end is embodied as a rotating joint (7) which rotationally connects the pressure rod (2) to a traction system (8). The axial ends of the hollow body (1) are respectively provided with a cap (5). The hollow body (1) is connected thereto along a casing line of the hollow body (1) in a non-positive fit. When the hollow body (1) is impinged upon by a pressurized fluid, the traction elements (4) are forced by the inflating hollow body (1) out of the straight connecting line between the fixing point (9) and the node (3) in the form of a screw and pull the node (3) into an activated position which is represented with dashed lines

The present invention relates to a pneumatic actuator according to the preamble of claim 1.

A number of fluid actuators without hydraulic or pneumatic cylinders are known explicitly or implicitly, for example from WO 03/074885 (D1) from the same applicant.

In D1, the actuator is constituted for example by a plate taking up compressive forces and a web of high-strength and low-expansion textile fabric provided laterally thereto. This web is fixed to the plate along several strips. Between the strips, bubbles of elastic material are inserted into the pocket between plate and web. A bending moment is exerted on the plate when compressed air is admitted to these bubbles and the plate is bent away laterally.

A drawback with this actuator is the fact that the compressive forces are taken up by a plate and it cannot therefore fall below a certain two-dimensional extension. In addition, it is especially suitable for the deformation of surfaces and for taking up line loads.

The problem of the present invention consists in providing actuators without pneumatic or hydraulic cylinders, which are suitable for the movement of fairly large point loads.

The solution to the problem is set out in the characterising part of claim 1 with regard to its main features and in the further claims with regard to supplementary advantageous developments.

With the aid of the appended drawings, the subject-matter of the invention is explained in greater detail using a number of examples of embodiment.

### IN THE FIGURES:

FIGS. 1a, b show diagrammatic representations of a first example of embodiment of an activated pneumatic actuator in side view and view from below,

FIG. 2 shows a diagrammatic representation of the first example of embodiment in a deactivated state in side view,

FIGS. 3a, b show diagrammatic representations of a second example of embodiment of an activated pneumatic actuator in side view and view from below,

FIG. 4 shows a diagrammatic representation of the second example of embodiment in a deactivated state in side view,

FIG. 5 shows a diagrammatic representation of a third example of embodiment in a deactivated state in side view,

FIGS. 6a, b show a diagrammatic representation of a fourth example of embodiment in an activated state in an isometric projection and view from below,

FIG. 7 shows a diagrammatic representation of a fifth example of embodiment in side view,

FIG. 8 shows a diagrammatic representation of a sixth example of embodiment in an isometric projection,

FIGS. 9a, b show diagrammatic representations of a seventh example of embodiment in side view,

FIG. 10 shows a diagrammatic representation of the actuator of the seventh example of embodiment in side view.

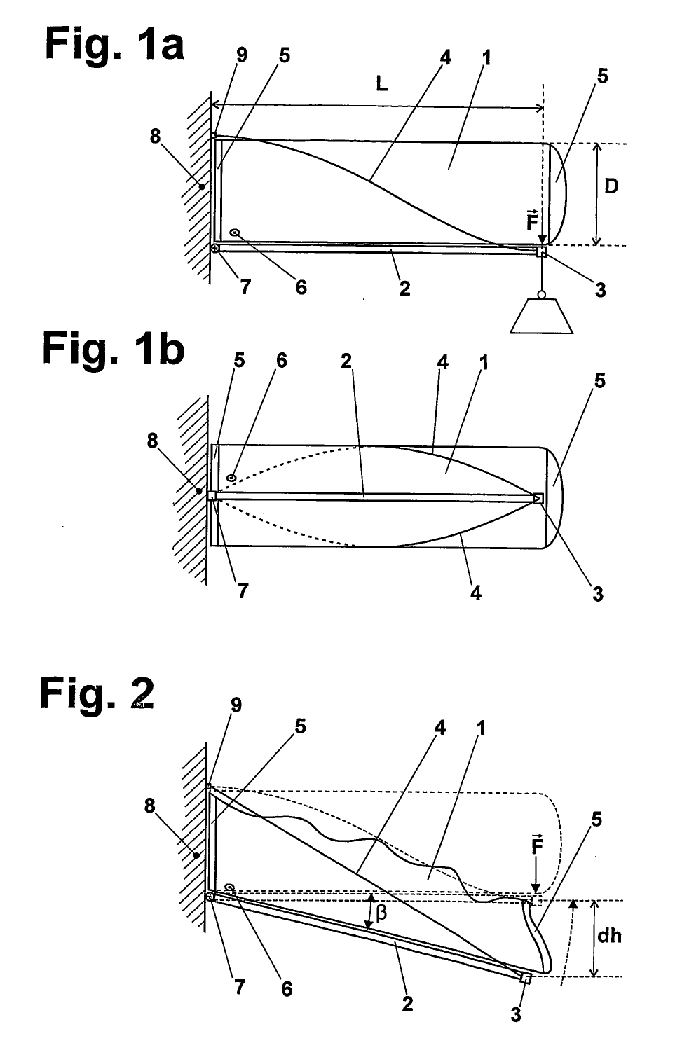

A first example of embodiment is shown diagrammatically in FIGS. 1a,b. Fig. 1a shows the activated pressurised actuator in side view and FIG. 1b in a view from below. The actuator shown comprises an elongated, essentially cylindrical hollow body 1 of length L and diameter D acted upon by a pressurised fluid, said hollow body being produced from a flexible and airtight material. Fitted at its underside is a flexurally stiff compression member 2 capable of taking up axial forces. Its free end is designed as node 3, to which two tension elements 4 are fixed in each case, and the other end is designed as a hinge 7, which connects compression member 2 in a rotary fashion to a reference system 8 for example a wall. The axis of hinge 7 stands essentially normal to the plane defined by compression member 2 and fixing point 9. The axial ends of hollow body 1 each carry a cap 5. Hollow body 1, for example cap 5 facing reference system 8 is equipped with a valve 6 for the aeration and evacuation of hollow body 1. Compression member 2 is connected along a surface line of hollow body 1 in a friction-locked manner with the latter. When hollow body 1 is essentially pressurised, compression member 2 is secured by hollow body 1 against buckling.

The two tension elements 4 wind around hollow body 1 in a helical manner in an opposite sense of rotation each in a half turn with constant pitch. They meet one another at a fixing point 9 lying above hing 7. The two tension elements 4 are connected in a friction-locked manner to reference system 8 at this fixing point 9.

This example of embodiment corresponds structurally to a half pneumatic structural member, as is disclosed in WO 01/73245 (D2). Half of the pneumatic beam from D2 is turned through 180 degrees about the longitudinal axis and the middle of the element from D2 is connected to reference system 8. The load force in D2 corresponds in the actuator to the supporting force and the supporting force in D2 likewise corresponds in the reverse direction to the new load force at the free end of the actuator.

FIG. 2 shows the first example of embodiment in a pressure-less deactivated state; the activated state is indicated with dashed lines. Tension elements 4 now connect node 3 to fixing point 9 in a direct straight line instead of a helical line. Compression member 2 is thus deflected downwards through angle β by a load force F acting downwards on node 3.

The following applies for γ=L/D:

$$β = arcsin ( \frac{1}{2 γ} ( \frac{{π}^{2}}{4} - 1 ) ) \qquad ( equation 1 )$$

For different γ, this produces for example the following angles β: γ=10→β=4.2° or γ=5→β=8.4°.

When hollow body 1 is pressurised with a hydraulic fluid, tension elements 4 are forced by expanding hollow body 1 out of the straight connecting line between fixing point 9 and node 3 into a helical shape and therefore pull node 3 out of the deactivated initial position into the activated position as in FIG. 1. Actuator regulating path dh is dependent on diameter D.

$$dh = L \cdot sin β = L \cdot ( \frac{1}{2 γ} ( \frac{{π}^{2}}{4} - 1 ) ) = D \cdot ( \frac{{π}^{2}}{8} - \frac{1}{2} ) \approx 0.734 \cdot D \qquad ( equation 2 )$$

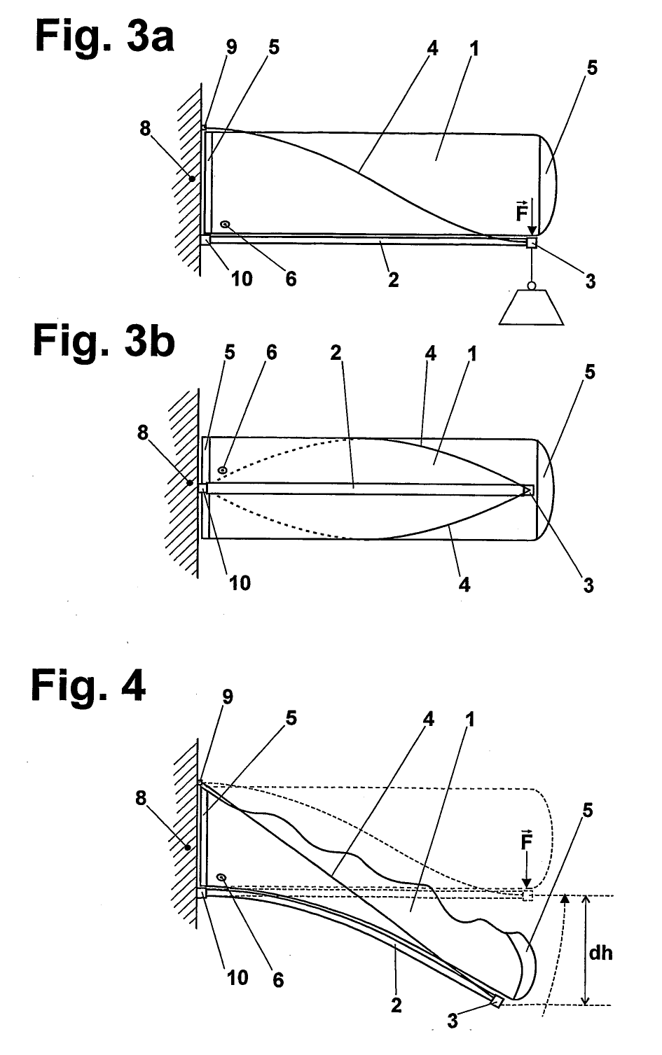

FIGS. 3a, b a second example of embodiment in side view and view from below. In contrast with the first example of embodiment, compression member 2 is designed as a flexible, flexurally elastic compression element. Such flexurally elastic compression elements have already been disclosed in document PCT/CH2004/00111 (D3). At the same time, compression member 2 must be clamped in reference system 8 by means of connection piece 10 in a friction-locked manner and not be mounted in a rotary fashion.

Load force F, acting at the free end of the actuator on node 3, must not be so great that flexible, flexurally elastic compression member 2 is buckled.

FIG. 4 shows the second example of embodiment in the deactivated state.

Common to the two aforementioned examples of embodiment is the fact that the maximum exertable actuator force is achieved with the maximum actuator regulating path, since the buckle-stabilising effect of hollow body 1 is also greater with increasing excess pressure in hollow body 1. This is in contrast with most other pneumatic actuators, such as pneumatic muscles for example, where the actuator force diminishes with increasing actuator regulating path.

The aforementioned examples of embodiment can also be operated with constant excess pressure in hollow body 1 and thus function as very lightweight cantilevers which have at the same time a very good bearing capacity. In this function, additional compression members 2 with accompanying pairs of tension elements 4 can be arranged around hollow body 1 in order to enable loading of the cantilevers in more than one transverse direction. At least three compression members 2 are required to take up forces from all transverse directions. In the case of use as an actuator, however, the number of compression members remains restricted to a single one.

Such a cantilever also has very good damping properties and can be used as a combined damping element, spring element and bearing-structure element in the case of load variations and fluctuations.

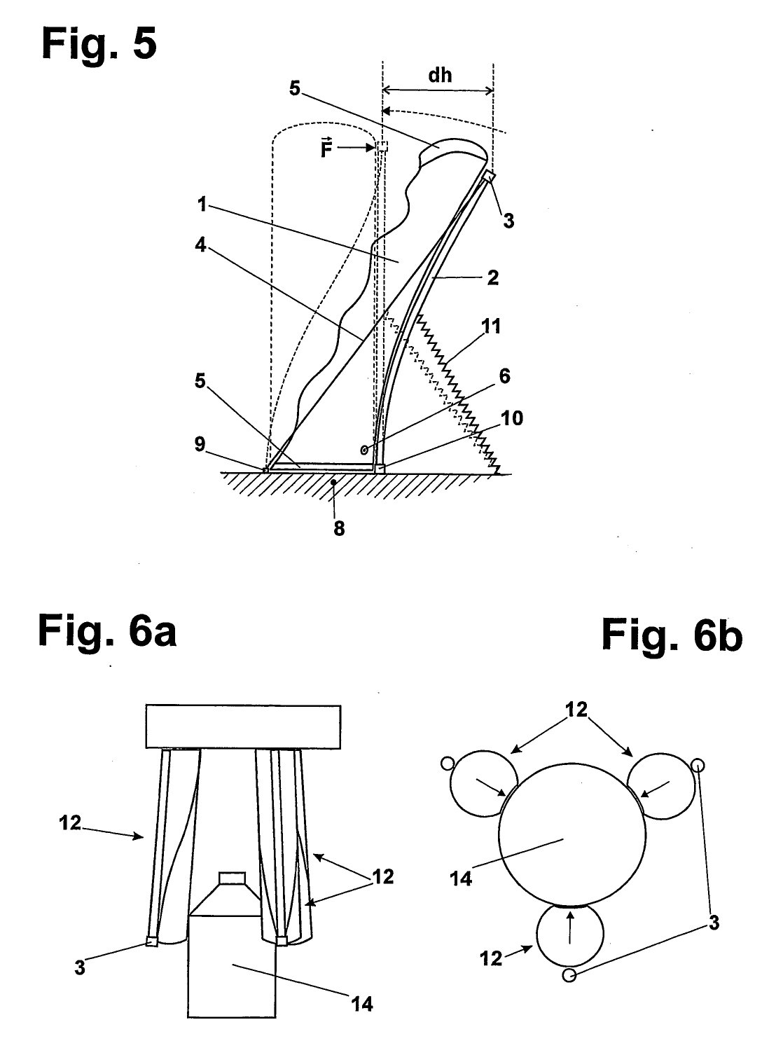

FIG. 5 shows a third example of embodiment of a pneumatic actuator in the deactivated state; the activated state is indicated with dashed lines. If the actuator cannot be assembled in such a way that the weight of compression member 2, tension elements 4 and hollow body 1 acts as a restoring force and the actuator counteracts the force of gravity, the resetting of the actuator into the initial deactivated position with emptied hollow body 1 can take place for example by means of a spring element 11, which is attached to reference system 8 and to compression member 2. The function of spring element 11 can be assumed for example by a helical spring of steel or an elastomer. It therefore plays no role as to whether the first or second example of embodiment is correspondingly extended. In the case of the first example, spring element 11 can be integrated directly into hing 7. Proceeding from the second example of embodiment, it is also feasible, and in accordance with the invention, for compression member 2 itself to act as a spring and to occupy independently the deactivated, arc-shaped initial position.

In a fourth example of embodiment in FIGS. 6a, b, three pneumatic actuators 12 according to the third example of embodiment form a gripping device, for bottles 14 for example. FIG. 6a shows a side view of the gripping device and FIG. 6b shows a view from below. The three actuators 12 are arranged uniformly around the circumference of a circle and act in a radial direction towards the centre-point. The gripping device is positioned with deactivated actuators 12 over bottle 14. When actuators 12 are activated, the latter close firmly around bottle 14 and the gripping device can be repositioned together with the bottle. The contact with the gripped object is produced in this example of embodiment directly by means of hollow bodies 1 which, for example, are non-skid-coated. This arrangement is of interest especially for the gripping of fragile objects. Also in accordance with the invention, however, are embodiments in which special gripping bodies are fixed for example to nodes 3 and pneumatic actuator 12 itself never comes into direct contact with the gripped object.

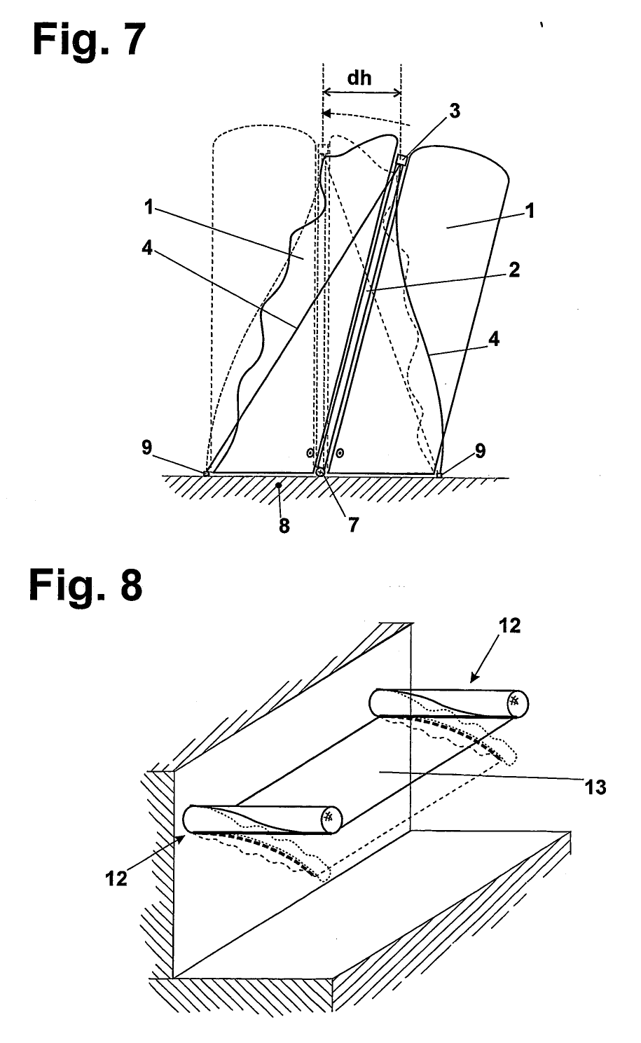

FIG. 7 shows a fifth example of embodiment of a pneumatic actuator. The active motion of the aforementioned actuators goes only in one direction. A further force, such as for example a spring force or the force of gravity, is therefore required for the resetting of the actuator. In the fifth example of embodiment, a second hollow body 1 with a pair of tension elements 4 is also present, said second hollow body counteracting as an antagonist the first hollow-body tension-element arrangement. The two extreme positions (represented in FIG. 7 by dashed and unbroken lines) of the actuator regulating path can thus be actively occupied by the actuator. The actuator shown is based on the first example of embodiment with a hinge 7 and a flexurally stiff compression member 2. An actuator of this kind can however also be produced equally well based on the second example of embodiment with a flexurally elastic compression member 2, which is clamped in a friction-locked manner by means of connection piece 10. The two fixing points 9 and hinge 7 or connection piece 10 essentially lie on a straight line.

FIG. 8 shows a sixth example of embodiment and a further possible application for a pneumatic actuator. Two pneumatic actuators according to FIGS. 3, 4, which are mounted as mobile cantilevers on a wall, stretch a membrane 13 to form a canopy roof. Pneumatic actuators 12 in the deactivated position are shown with dashed lines. In this position, membrane 13 can readily be hung up on compression members 2, for example at eyelets. Watertight membrane 13 acting as a roof is stretched tight when actuators 12 are activated in the axial direction of compression members 2.

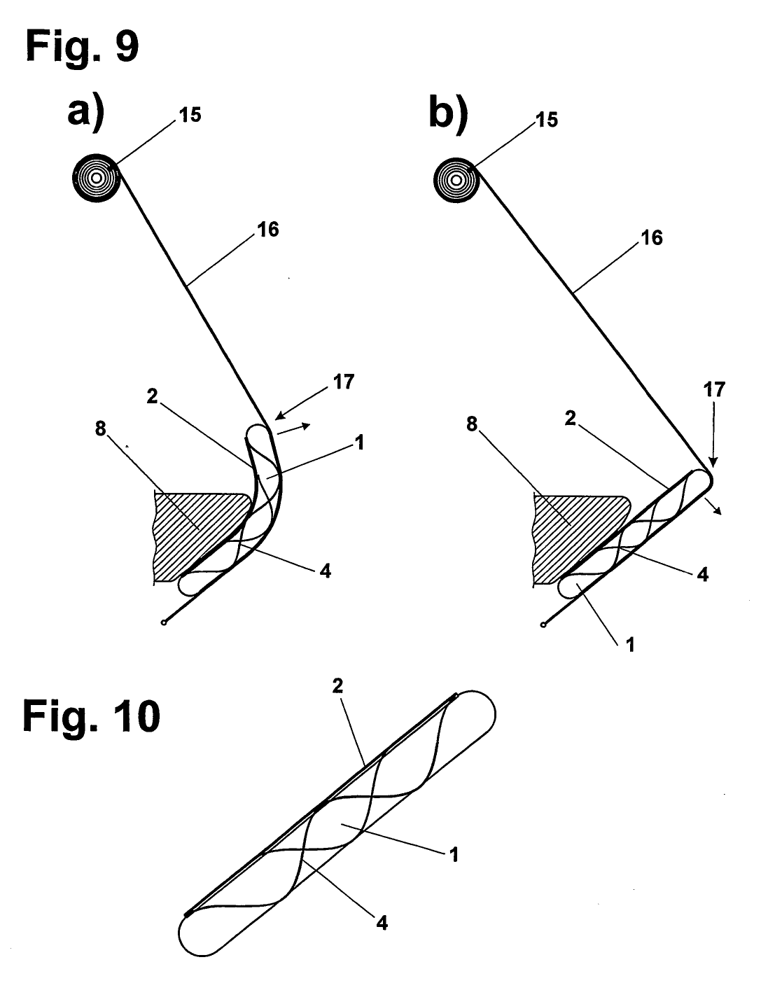

FIGS. 9a, b show a seventh example of embodiment of an actuator according to the invention for an application as a belt server, for example in a motor vehicle. The arched, non-activated, i.e. non-pressurised, actuator has a flexurally elastic compression member 2 on the inside of the arc. Belt 16 stretched by a roll-up device 15 pulls the inactive actuator into an arc shape. The assumption of this arc shape can be assisted by a suitably shaped reference system 8 serving as a stop. Hollow body 1 is wrapped around helically by at least one pair of tension elements 4 in each case pairwise in an opposite sense of rotation at least in one whole convolution. In contrast with the examples of embodiment shown above, tension elements 4 are laid in a whole turn or in a multiple of complete turns around hollow body 1 and are connected at both ends of the actuator to compression member 2. Nodes 3 respectively at both ends of compression member 2 can be present for the friction-locked connection of compression member 2 and tension elements 4. The connection of tension elements 4 to compression member 2 can be provided over the whole length of compression member 2, in order to enable favourable angles of application of tension elements 4 on compression member 2 during bending of the actuator. For this purpose, more than two nodes 3 fixed to compression member 2 can also be provided. Compression member 2 or a part of the actuator can be connected at a first end to reference system 8. This fixing is not absolutely essential. A reference system 8 formed as a stop may suffice to clamp the first end of the actuator during pressurisation between belt 16 and reference system 8. It is also feasible for a first end of hollow body 1 alone or together with the first end of compression member 2 to be connected in a friction-locked manner to references system 8. Belt 16 is connected to the actuator partially or over the whole length of the actuator. At least one connection is however present between belt 16 and the actuator at moved end 17 of the actuator. Many possibilities are known to the expert for such connections, e.g. they can be produced by means of brackets, a pocket or by gluing or sewing. When hollow body 1 is pressurised with compressed air, the actuator is moved and belt 16 is thereby extended forwards, after which belt 16 can conveniently be gripped by the occupant.

FIG. 10 shows the actuator of the seventh example of embodiment in detail. When a side of this actuator is fixed or clamped to reference system 8 the actuator may exert a force in the direction of the side opposite compression member 2 when hollow body 1 is pressurised with compressed air.

It is feasible, and in accordance with the invention, to use an actuator according to the first six examples of embodiment for the application as a belt server.

1. A pneumatic actuator in the form of a cantilever, characterised in that
an airtight and elongated hollow body (1) of flexible material pressurised with compressed air by means of at least one valve (6) is present,
at least one compression member (2) is present, and the latter lies along a surface line of the hollow body (1) adjacent to the latter and is secured against displacement and buckling, furthermore
that at least one pair of tension elements (4) is present, which are laid pairwise in an opposite sense of rotation around the hollow body (1) in a helical fashion,
and that a first end of the actuator is connected to a reference system (8) and a second end (17) of the actuator can perform a movement and/or exert a force relative to the reference system (8) depending on the pressurisation of the hollow body (1) with compressed air.

2. The pneumatic actuator according to claim 1, characterised in that
the compression member is connected at one end to a reference system. (8), furthermore
the at least one pair of tension elements (4) are fixed on the one hand to a free end of the compression member (2), for which purpose the compression member (2) has a node (3) at the free end for the mutual friction-locked fixing of compression member (2) and tension elements (4) and so as to take up load forces,
whereby, furthermore, the at least one pair of tension elements (4) is laid around the hollow body (1) in a helical and countra-rotational fashion with a half convolution and, on the other hand, is connected for its part in a friction-locked manner to a fixing point (9) connected in a friction-locked manner to the reference system (8),
whereby the fixing point (9) and the compression member (2) lie in the plane of motion of the actuator.

3. The pneumatic actuator according to claim 2, characterised in that
the compression member (2) is clamped at one end in a friction-locked manner by means of a connection piece (10) connected in a friction-manner to the reference system (8),
the axial direction of the end of the compression member (2) clamped in the connection piece (10) remains essentially unchanged even under loading of the node (3),
the compression member (2) is produced from flexible, flexurally elastic material and is bent under loading of the node (3).

4. The pneumatic actuator according to claim 2, characterised in that
the compression member (2) is connected in a rotary and friction-locked manner to the reference system (8) by means of a hinge (7),
the rotary axis of the hinge (7) stands at right angles both to the axial direction of the compression member (2) and to the connecting line of the hinge (7) to the fixing point (9),
the compression member (2) is produced from flexurally stiff material.

5. The pneumatic actuator according to any one of claims 1 to 4, characterised in that the actuator is reset from the activated position into the deactivated position by means of a spring element (11).

6. The pneumatic actuator according to any one of claims 1 to 4, characterised in that the actuator has a further fixing point (9) to the reference system (8) in the plane formed by the compression member (2) and the fixing point (9) and has in addition a second hollow body (1) as well as at least one further pair of tension elements (4), as a result of which the two extreme positions of the actuator regulating path can actively be occupied by the actuator.

7. The pneumatic actuator according to claim 1, characterised in that
the compression member (2) is produced from flexurally elastic material,
the at least one pair of tension elements (4) are laid around the hollow body (1) in a whole turn or in multiples of a whole turn,
the at least one pair of tension elements (4) is fixed in a friction-locked manner respectively to the two ends of the compression member (2).

8. The pneumatic actuator according to claim 7, characterised in that the compression member (2) is connected to the reference system (8) partially in a friction-locked manner at the first end of the actuator.

9. The pneumatic actuator according to any one of claims 1 to 8 , characterised in that means are present for pressurisation of the hollow body (1) with compressed air and for blowing the air out of the hollow body (1).

10. Use of a pneumatic actuator according to any one of claims 1 to 9 as a damping spring element.

11. Use of at least two pneumatic actuators according to any one of claims 1 to 9 as a gripping device.

12. Use of a pneumatic actuator according to any one of claims 1 to 9 as a cantilever with constant pressurisation of the hollow body.

13. Use of a pneumatic actuator according to any one of claims 1 to 9 for the production of a pneumatically driven belt server.
